(19) United States
(12) Patent Application Publication
(10) Pub. No.: US 2019/0322553 A1
(43) Pub. Date: Oct. 24, 2019

(54) SYSTEM AND METHOD FOR SEPARATING NUTRIENTS FROM A WASTE STREAM

(71) Applicant: ClearCove Systems, Inc., Victor, NY (US)

(72) Inventor: Terry Wright, Rochester, NY (US)

(21) Appl. No.: 15/956,809

(22) Filed: Apr. 19, 2018

(51) Int. Cl. C02F 1/52; C02F 1/44; C02F 11/12; C02F 11/04

(52) U.S. Cl. CPC C02F 1/52; C02F 1/444; C02F 1/441; C02F 2303/20; C02F 11/125; C02F 11/123; C02F 11/04; C02F 11/127

(57) ABSTRACT

A system and method to separate and concentrate nutrients from process waste water comprising the steps of accumulating the process waste water in a settling tank; settling the solids to form a supernatant and settled sludge; filtering the supernatant with a filtration system to form a permeate and a concentrate; dewatering the settled sludge to form thickened solids and a pressate; and, blending the thickened solids and the concentrate to form a slurry.

### FIELD OF THE APPLICATION

### Background

The present invention is directed to systems for treatment of waste water and more particularly, to systems for removing solids and solvated material from waste water. It is known that waste water, such as municipal waste water and process waste water resulting from agricultural, food and beverage processes, contains nutrients supporting biological growth. Nutrient examples include proteins, sugars, fats, oils, alcohol, phosphorous-containing compounds, and nitrogen-containing compounds. When discharged directly into the environment these compounds are considered pollutants that can lead to undesirable growth of pathogenic bacteria, eutrophication of watersheds, and other undesirable effects. Consequently, one common objective of waste water treatment is the removal or reduction of these nutrients to produce treated water that can safely be discharged into the environment.

Currently, the most common method for removal of nutrients from waste water involves the use of primary treatment systems to settle solids as sludge for disposal in landfills and secondary treatment systems using bacteria which consume the nutrients, thus removing them from the waste stream. While the bacteria are dense enough and large enough to settled or filtered from the waste stream, they present several challenges. It is difficult to timely monitor the health of the bacteria. Unanticipated changes in the composition of the waste stream can kill, sicken, or starve the bacteria. In addition, the settled or filtered bacteria create another solid to be disposed of, typically in a landfill.

A better solution for treatment of waste water is to extract the nutrients, permitting them to be re-purposed for other applications such as fertilizer or as feed-stock for anaerobic digester energy production.

The extraction of nutrients from waste water poses several challenges. The various materials comprising the nutrients present in waste water typically possess a broad range of physical and chemical properties such that there is no single method to efficiently extract them. By way of example, some materials, such as proteins, may be easily removed via coalescence and settling. Conversely, other compounds may be more effectively removed via microfiltration and ultrafiltration, and for very small molecules and ions such as sugars and aqueous salts nanofiltration and reverse osmosis systems are required. Each filtering technique has its own advantages and limitations. Microfiltration is typically effective for removal of particulate matter with a size range of about 0.1 μm to about 10 μm. Nanofiltration, ultrafiltration and reverse osmosis are all pressure-driven filtration processes requiring high pressure pumps, CIP (clean in place) subsystems, and pre-treatment of the influent, for example, to prevent filter membrane fouling.

Ultrafiltration is typically effective for removal of matter with a size range of about 0.005 μm to about 0.1 μm and nanofiltration is typically effective for removal of colloidal and dissolved matter down to about 0.001 μm. Reverse osmosis is used for even smaller particles and is typically effective for removal of dissolved matter down to sizes as low as 0.0001 μm.

The application of each of these types of filtration systems to typical industrial waste stream is complicated by the need to keep the filtration membranes from fouling by the relatively high concentrations of materials larger than their target exclusion size, e.g., fibers, hair, and various food and grain remnants.

A further challenge is that the nutrients are typically present in low concentrations creating a need to efficiently concentrate the nutrients for their re-purposing. By way of example, a typical waste stream from a brewery may have a total solids content of 1500 mg/l, with nitrogen concentration of about 30 mg/l to 100 mg/l and phosphorous content of about 30 mg/l to 100 mg/l.

What is needed is a system and method to extract and concentrate nutrients from waste water such that the nutrients can be efficiently and cost-effectively repurposed.

### SUMMARY OF THE INVENTION

As disclosed in U.S. Pat. No. 7,972,505, “Primary Equalization Settling Tank”; U.S. Pat. No. 8,225,942, “Self-Cleaning Influent Feed System for a Waste Water Treatment Plant”; U.S. Pat. No. 8,398,864, “Screened Decanter Assembly”; U.S. Pat. No. 9,643,106 “Screen Decanter for Removing Solids from Wastewater”; U.S. Pat. No. 9,744,482, “Screen Decanter for Screening Solids from Waste Water”; U.S. Pat. No. 9,782,696, “Method for Maximizing Uniform Effluent Flow Through a Waste Water Treatment System; pending U.S. patent application Ser. No. 14/141,297, “Method and Apparatus for a Vertical Lift Decanter System in a Water Treatment Systems”; U.S. patent application Ser. No. 14/142,099, “Floatables and Scum Removal Apparatus”; U.S. patent application Ser. No. 14/325,421, “IFS and Grit Box for Water Clarification Systems”; and U.S. patent application Ser. No. 14/471,247 “Method and Apparatus for Using Air Scouring of a Screen in a Water Treatment Facility”; U.S. patent application Ser. No. 14/985,842, “System for Processing Wastewater” (hereinafter the '842 application); U.S. patent application Ser. No. 15/887,987 “Improved System and Method for Static Mixing in a EPT Using a Fluid Containment Assembly” (hereinafter the '087 application); the inventor has developed systems and processes for treatment of waste water. The above-named applications and patents are incorporated herein by reference in their entirety for all purposes.

A new improved apparatus and method to separate nutrients from a waste stream is now described. A system and method to separate and concentrate nutrients from process waste water comprising the steps of accumulating the process waste water in a settling tank; settling the solids to form a supernatant and settled sludge; filtering the supernatant with a filtration system to form a permeate and a concentrate; dewatering the settled sludge to form thickened solids and a pressate; and, blending the thickened solids and the concentrate to form a slurry.

Further features and advantages of the present invention will become apparent to those of ordinary skill in the art in view of the drawings and detailed description of preferred embodiments below.

### BRIEF DESCRIPTION OF THE DRAWINGS

The features of the application can be better understood with reference to the drawings described below and to the claims. The drawings are not necessarily to scale, emphasis instead generally being placed upon illustrating the principles described herein. In the drawings, like numerals are used to indicate like parts throughout the various views.

FIG. 1 provides a description of a system for extracting and concentrating nutrients from a waste stream in accordance with the instant application.

FIG. 2 provides an overview of an influent delivery system and a settling tank as disclosed in the '987 application.

FIG. 3 provides an isometric view of decanter assembly 1400, as further disclosed in the '842 application.

FIG. 4 provides a second isometric view of decanter assembly 1400, as further disclosed in the '842 application.

FIG. 5 provides a flow chart of a method for extracting and concentrating nutrients from a waste stream in accordance with the instant application.

FIG. 6 provides a description of an alternate embodiment of a system for extracting nutrients from a waste stream in accordance with the instant application.

FIG. 7 provides a description of a sludge tank used to thicken solids in accordance with the instant application.

FIG. 8 provides a description of a representative ultrafiltration system in accordance with the instant application.

FIG. 9 provides a flow chart of a preferred embodiment for extracting nutrients from a waste stream in accordance with the instant application.

### DETAILED DESCRIPTION OF THE INVENTION

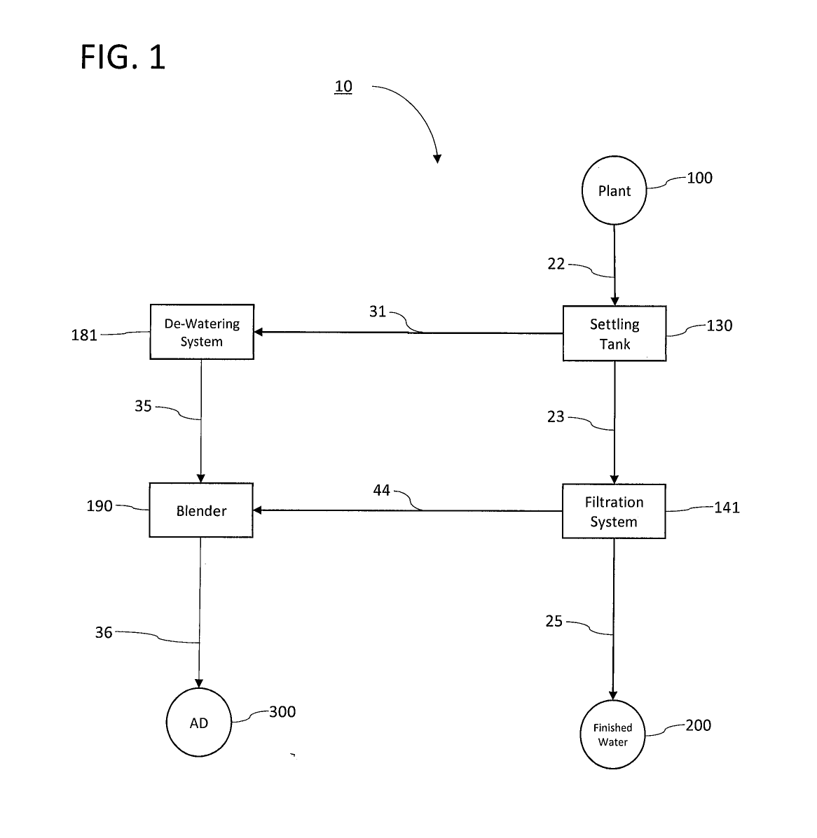

With reference to FIG. 1, in a preferred embodiment of the instant application, a system 10 for extracting nutrients from process waste water comprises a settling tank 130 to accumulate process waste water 22 from a plant 100.

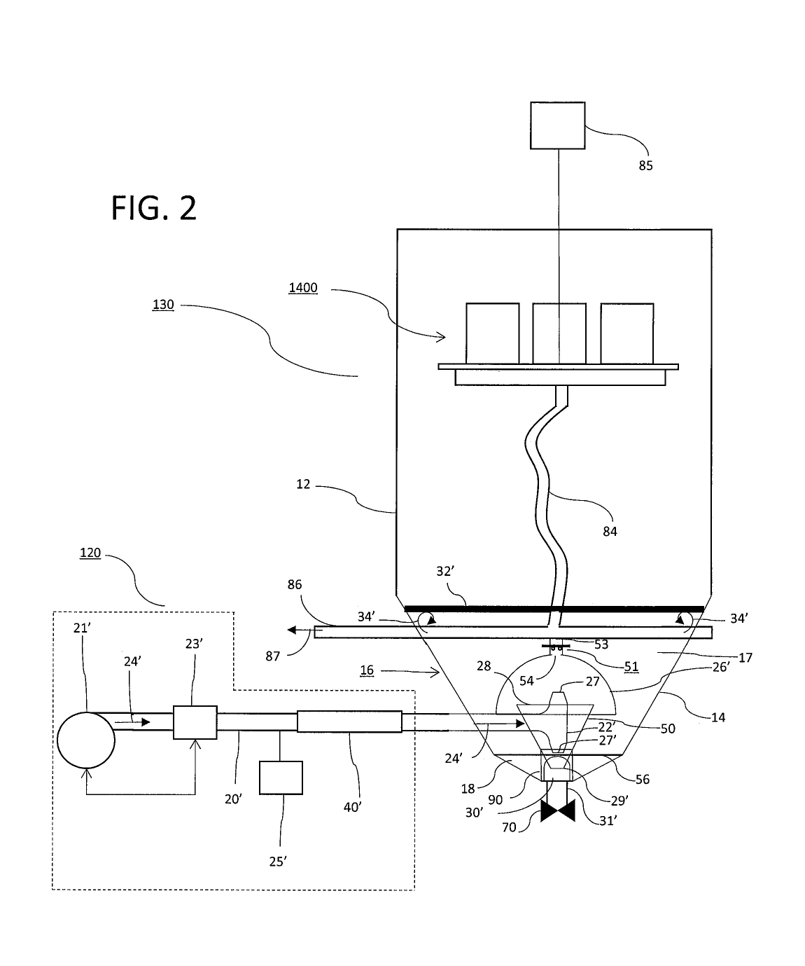

In a currently preferred embodiment, settling tank 130 is substantially similar to the settling tank disclosed in the '087 application. With reference to FIG. 2, and as disclosed in more detail in the '987 application, in a preferred embodiment, settling tank 130 comprises a tank 12 provided with a sludge hopper 14 in a bottom portion 16 of tank 12 (not to scale). The sludge hopper 14 comprises an upper portion 17 and a lower portion 18 separated by a scouring plate 56. Sludge hopper 14 further comprises a bottom opening 30′, drain 31′, and drain valve 70.

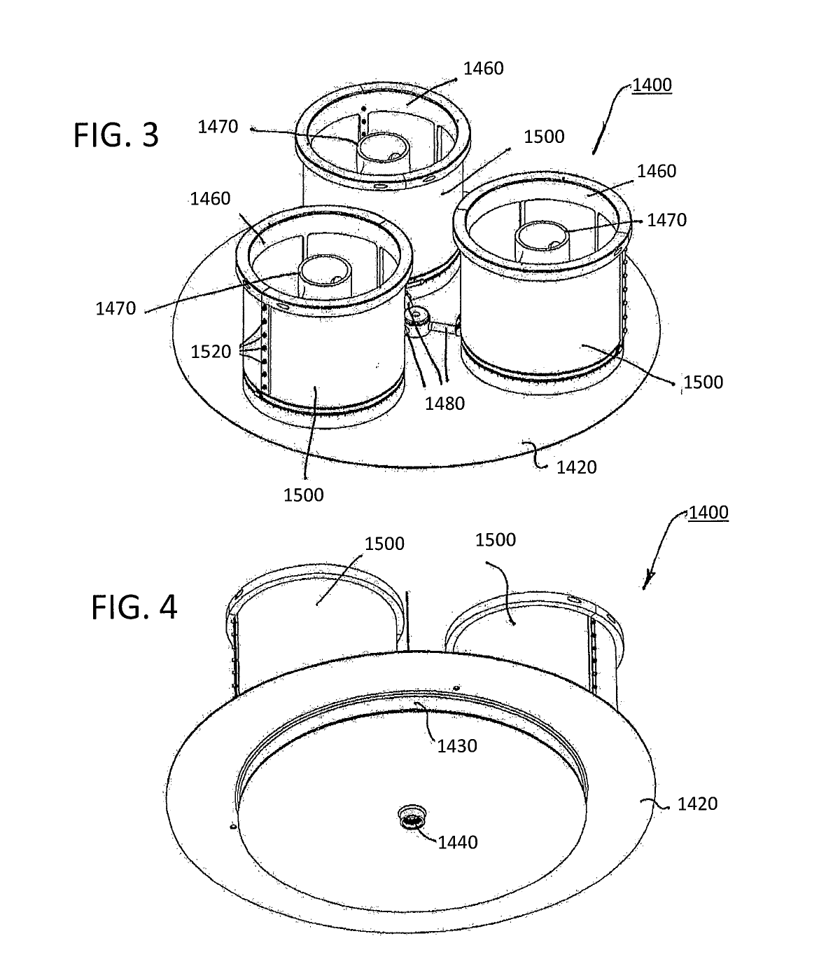

A decanter assembly 1400 is provided within the clarification tank 12. Preferably, decanter assembly 1400 is substantially similar to the exemplary decanter assembly of the '842 application as shown in FIG. 3 and FIG. 4. Decanter assembly 1400 comprises a platform 1420 including a drain manifold 1430 having a central drain opening 1440. Three decanter frames 1460 are mounted to platform 1420. Each decanter frame 1460 includes a perforated central standpipe 1470 that extends through an opening in the lower portion of the decanter frame 1460 to connect to drain manifold 1430. Each frame 1460 is surrounded by a cylindrical screen 1500 connected to frame 1460 such as by screws 1520 in such a fashion that all influent flow entering frames 1460 must pass through a screen 1500. Preferably, screens 1500 have a porosity in the range of 25-75 micrometers, and most preferably about 50 micrometers.

With reference to FIG. 2, drain manifold 1430 (FIG. 4) is in fluid communication with effluent hose 84, which in turn is in fluid communication with effluent pipe 86 to decant screened waste water 87 that passes through the decanter frames 1460, drain manifold 1430, and effluent pipe 86. The decanter assembly 1400 is at an elevation higher than the sludge hopper 14 and is raised and lowered via vertical lift mechanism 85 to follow vertical changes in the upper surface of waste water within the tank 12. Influent waste water 24′ is delivered to settling tank 130 via waste water influent pipe 20′.

Referring again to FIG. 1, settling tank 130 is in fluid communication with filtration system 141 and arranged to deliver the supernatant 23 resulting from settling solids out of the process waste water 22. Settling tank 130 is additionally in fluid communication with dewatering system 181 and arranged to deliver the sludge 31 resulting from settling solids from the process waste water 22 in settling tank 130 to dewatering system 181. In a preferred embodiment, as described in more detail hereinafter, dewatering system 181 further comprises a gravity thickening tank to first gravity-thicken the sludge and a belt filter press to dewater the gravity-thickened sludge. Other apparatus may be used to dewater and/or thicken the sludge 31, including without limitation a centrifuge, rotary press, screw press and filter press as dictated by the needs of the application.

Filtration system 141 is in fluid communication with blender 190 and arranged to deliver the filtration system reject, or concentrate, from filtration of supernatant 23 to blender 190. Filtration system 141 permeate 25 is discharged from system 10 as finished water. Filtration system 141 may comprise without limitation a micro-filtration system, ultra-filtration system, nanofiltration system and reverse-osmosis system or some combination thereof as dictated by the requirements of the application.

Blender 190 is in fluid communication with dewatering system 181 to receive thickened solids 35 and in fluid communication with filtration system 141 to receive concentrate 44. Blender 190 blends the thickened solids 35 and concentrate 44 to form slurry 36. In a preferred embodiment, slurry 36 is delivered to anaerobic digester 300.

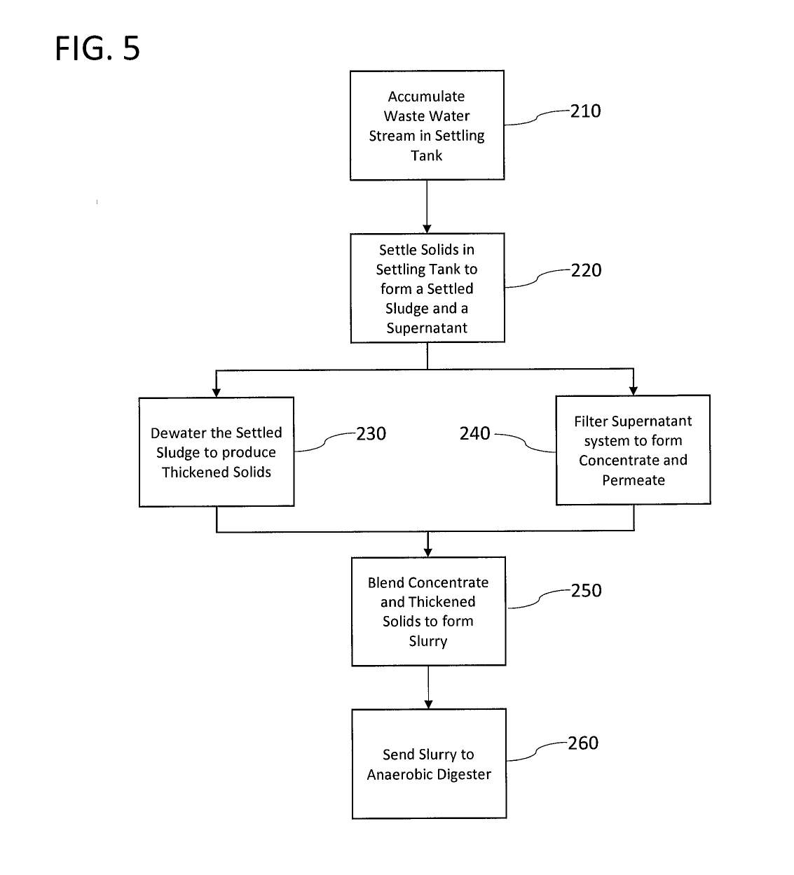

In operation, and with reference to FIG. 5, in step 210 process waste water from a food processing application is accumulated in a settling tank. The process waste water is rich in nutrients, commonly measured in terms of biological oxygen demand or BOD. Note: “Biological Oxygen Demand” (BOD), also known as Biochemical Oxygen Demand, is the amount of oxygen needed by aerobic microorganisms to decompose all the digestible organic matter in a sample of water; it is used in the eco-sciences as a measure of organic pollution. As used herein, the term “BOD” also means more generally the unit volume load, both dissolved and suspended, of such organic material in waste water.

The nutrients may be dissolved in the process waste water or may be particulate. The total amount of particulate matter in the process waste water is commonly referred to as Total Suspended Solids (TSS). TTS is a water quality measurement which, as used herein, is expressed as the unit volume load of suspended solids, both organic and inorganic, in water. It is listed as a conventional pollutant in the U.S. Clean Water Act.

After accumulating the process waste water in the settling tank, and with reference to step 220, solids settle to the bottom of the settling tank during a “settle time” resulting in the formation of a separated sludge and supernatant. Both the sludge and the supernatant may contain significant nutrients that can be used, as for instance in an anaerobic digester to produce methane. Generally, the supernatant will have a relatively greater concentration of nutrients dissolved in the fluid and relatively lesser concentration as suspended particles when compared to the sludge.

In a preferred embodiment using the settling tank 130 (reference FIG. 2) disclosed in the '987 application, more than 90% of particulate matter is efficiently extracted from the process waste water to form a sludge high in BOD and phosphorous. Preferably, the supernatant of step 220 is decanted from preferable settling tank 130 via a decanter assembly 1400 substantially similar to the exemplary decanter assembly of the '842 application as described elsewhere in this instant application with reference to FIG. 3 and FIG. 4 to remove residual particulate matter larger than the pore size of screens 1500. It is further preferable that screen 1500 have a pore size in the range of 25-75 micrometers, and most preferably about 50 micrometers. In this preferred embodiment, the supernatant decanted via decanter assembly 1400 to produce screened waste water 87 (FIG. 2.) corresponds to supernatant 23 of FIG. 1. Other important nutrients such as sugars, alcohols, fatty acids, NPN (non-protein nitrogen), and other organic compounds will predominantly remain solvated or suspended in the supernatant. To extract and concentrate the nutrients from the sludge and the supernatant, distinct process steps are used.

With reference to step 230, the sludge is dewatered to concentrate the nutrients found in the sludge, producing thickened solids, preferably thickened solids with 25%-40% total solids by weight. Thickened solids with a high concentration of total solids can be difficult to efficiently transport, e.g., using pumps.

With reference to step 240, the supernatant is filtered to form a permeate and a concentrate. In a typical water reuse application, the supernatant is highly filtered to permit discharge of the resulting permeate to reduce measured amounts of BOD, TSS, nitrogen-compounds, and other components to very low levels as required for discharge to municipalities, fields, streams, and the like. Consequently, high concentrations of supernatant nutrients are found in the filtration system concentrate.

With reference to step 250, to facilitate transport of the thickened solids, such as via pumps, and to create a more nutrient rich product, the thickened solids are blended with the concentrate to form a slurry, and in step 260 the slurry is sent to an anaerobic digester.

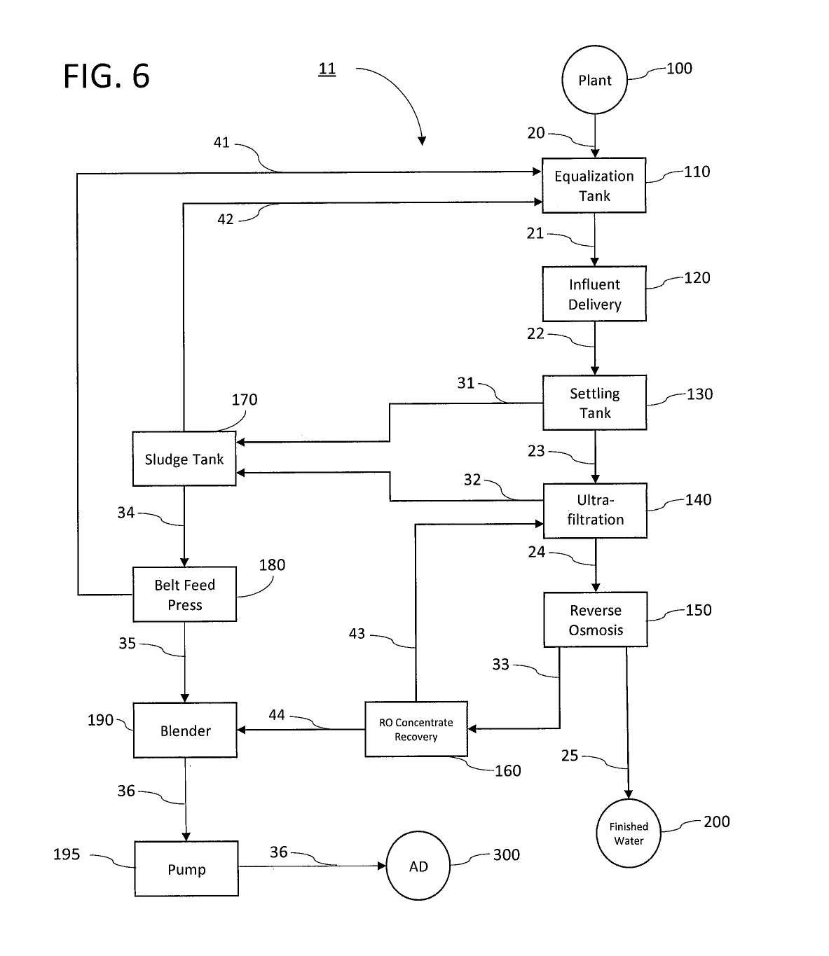

With reference to FIG. 6, in a second preferred embodiment of the instant application, a system 11 for extracting nutrients from process waste water comprises equalization tank 110 for receiving process waste water 20 discharged from plant 100. Equalization tanks for accumulating and potentially pre-treating process waste water are well known in the art. An influent delivery system 120 is in fluid communication with equalization tank 110 and settling tank 130 to transfer process waste water 21 from equalization tank 110 to settling tank 130. Optionally, influent delivery system 120 further comprises means for addition of coagulants and/or flocculants to enhance coalescence and settling of solids in the settling tank 130. In a currently preferred embodiment, influent delivery system 120 is substantially similar to the influent delivery system disclosed in the '987 application.

With reference to FIG. 2, and as described in more detail in the '987 application, in a currently preferred embodiment influent delivery system 120 comprises pump 21′ controlled by flow control apparatus 23′ which may include a flow meter, variable frequency drive, and control valving (not shown) in known fashion. Further, dosing apparatus 25′ may be provided for, e.g., adjusting pH of the influent or adding coagulants and/or flocculants thereto. In a currently preferred embodiment, influent pipe 20′ further includes an inline static mixer 40′, such as for example a helical auger, arranged to provide mixing of coagulants and/or flocculants with the influent stream.

Continuing with FIG. 6, settling tank 130 is in fluid communication with ultrafiltration (UF) system 140 and arranged to transfer the supernatant 23 resulting from settling solids out of the process waste water 22. Settling tank 130 is additionally in fluid communication with and arranged to transfer to sludge tank 170 the sludge 31 resulting from settling solids from the process waste water 22 in settling tank 130.

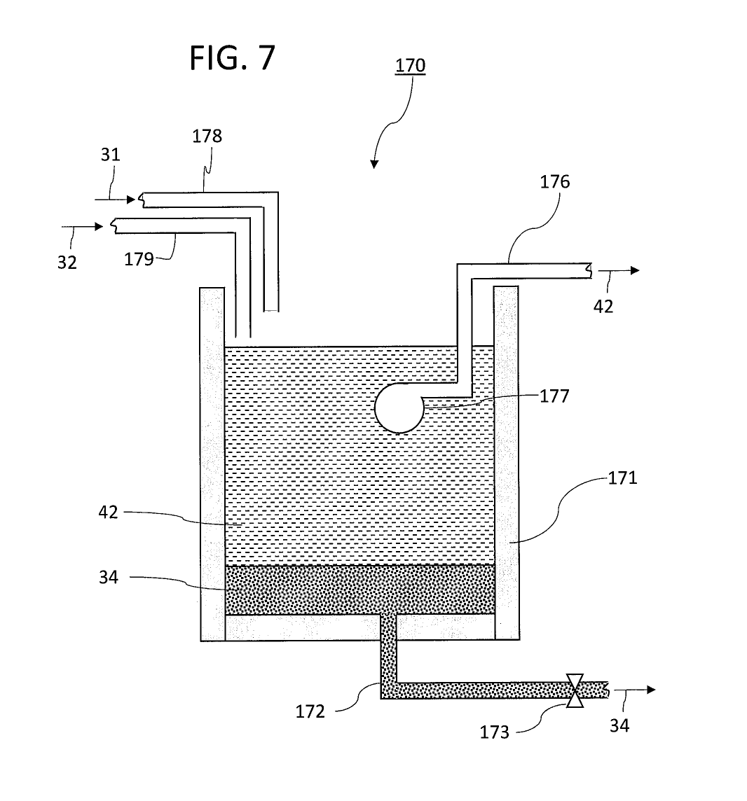

Referring now to FIG. 7, in a currently preferred embodiment, sludge tank 170 comprises a sludge settling tank 171, sludge drain 172, and valve 173 to control discharge of gravity-thickened sludge 34 through sludge drain 172. Sludge tank 170 further comprises pump 177 to discharge sludge supernatant 42 via discharge pipe 176. Sludge tank 170 receives settling tank sludge 31 via intake pipe 178 and, as described in more detail henceforth, ultrafiltration sludge 32 via intake pipe 179.

Referring again to FIG. 6, ultrafiltration system 140 is in fluid communication with reverse osmosis (RO) system 150 and arranged to transfer the UF (ultrafiltration) filtrate 24 to RO system 150 for filtration.

Ultrafiltration system 140 is in fluid communication with sludge tank 170 and arranged to transfer UF sludge 32 resulting from concentration of materials filtered out of the supernatant 23 to sludge tank 170.

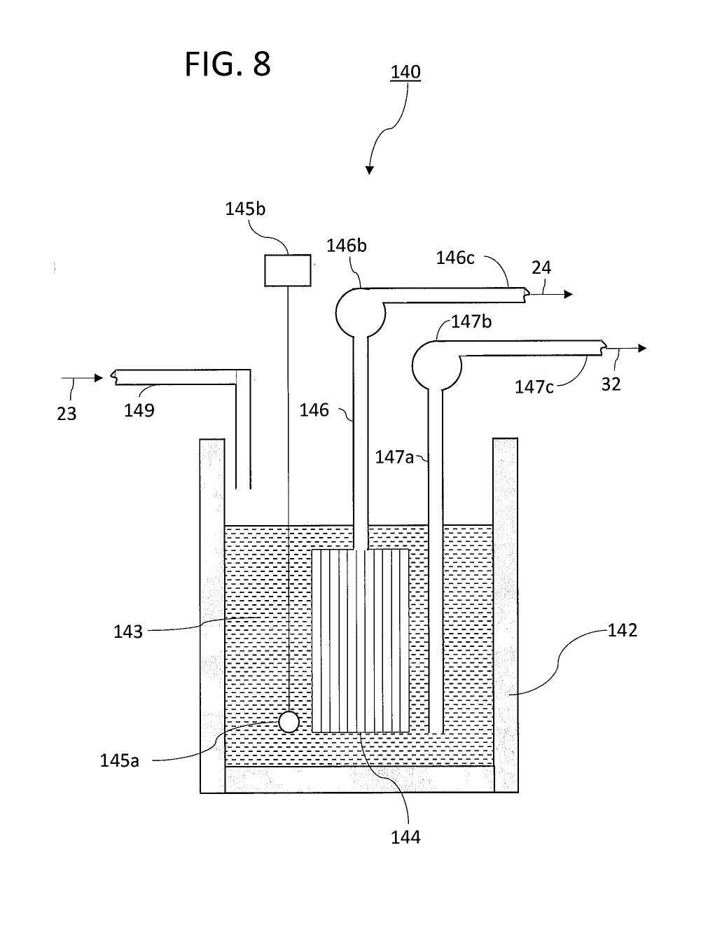

With reference to FIG. 8, in a currently preferred embodiment of the instant application, ultrafiltration system 140 comprises a feed tank 142 arranged to receive supernatant 23 via inlet pipe 149 for filtration by filter membranes 144. Feed tank 142 holds fluid 143 comprising supernatant 23 and materials that do not pass through the filter membranes 144 (the “reject”). In a preferred embodiment, filtration membrane 144 is a hollow fiber membrane with the fluid to be filtered passing through the outside of the fiber to the inner portion of the membrane. Filtration pump 146b creates a negative pressure to draw filtered fluid through the filter membrane 144 and connecting hose 146 for discharge as ultrafiltration filtrate 24 via discharge pipe 146c.

Sensor 145a and controller 145b are arranged to measure the concentration of rejected materials in fluid 143. During operation, the concentration of the reject will increase to a level that the efficacy of the ultrafiltration system is negatively impacted (e.g., membrane 144 may foul, throughput is reduced). When the reject concentration exceeds that level, the fluid 143 is discharged from tank 142 as ultrafiltration sludge 32 via discharge pump 147b and discharge pipes 147a and 147c. In a currently preferred embodiment, sensor 145a comprises a total suspended solids sensor. In alternative embodiments, sensor 145a may comprise a pH sensor, conductivity sensor, or turbidity sensor as dictated by the needs of the application.

Reverse osmosis system 150 is in fluid communication with reverse osmosis concentrate recovery system 160, a second reverse osmosis system. Reverse osmosis system 150 delivers the reject, or intermediate concentrate 33, from filtration of UF filtrate 24 for filtration by reverse osmosis concentrate recovery system 160. Reverse osmosis system 150 permeate 25 is discharged from system 10 as finished water.

Sludge tank 170 is in fluid communication with belt filter press 180 and delivers gravity-thickened sludge 34 to the belt press 180. Sludge tank 170 is further in fluid communication with EQ tank 110 and delivers supernatant 42 to EQ tank 110 as described herein with respect to FIG. 7.

Belt filter press 180 dewaters gravity-thickened sludge 34 to produce a pressate 41 and thickened solids 35. Belt filter press 180 is in fluid communication with blender 190 and delivers thickened solids 35 to blender 190. Belt filter press 180 is further in fluid communication with EQ tank 110 and delivers pressate 41 to EQ tank 110. Belt filter presses to dewater sludge are well known in the art. Alternatively, dewatering and/or thickening of any of sludge 31, ultrafiltration sludge 32, and gravity thickened sludge 34, may be accomplished by other apparatus, including without limitation, a centrifuge, rotary press, filter press, and screw press as dictated by the needs of the application.

Blender 190 is in fluid communication with RO concentration recovery 160 to receive concentrate 44. Blender 190 operates to macerate the thickened solids 35 and blend them with concentrate 44 to form a slurry 36. In a currently preferred embodiment, blender 190 is in fluid communication with a pump 195 that transfers slurry 36 to anaerobic digester 300.

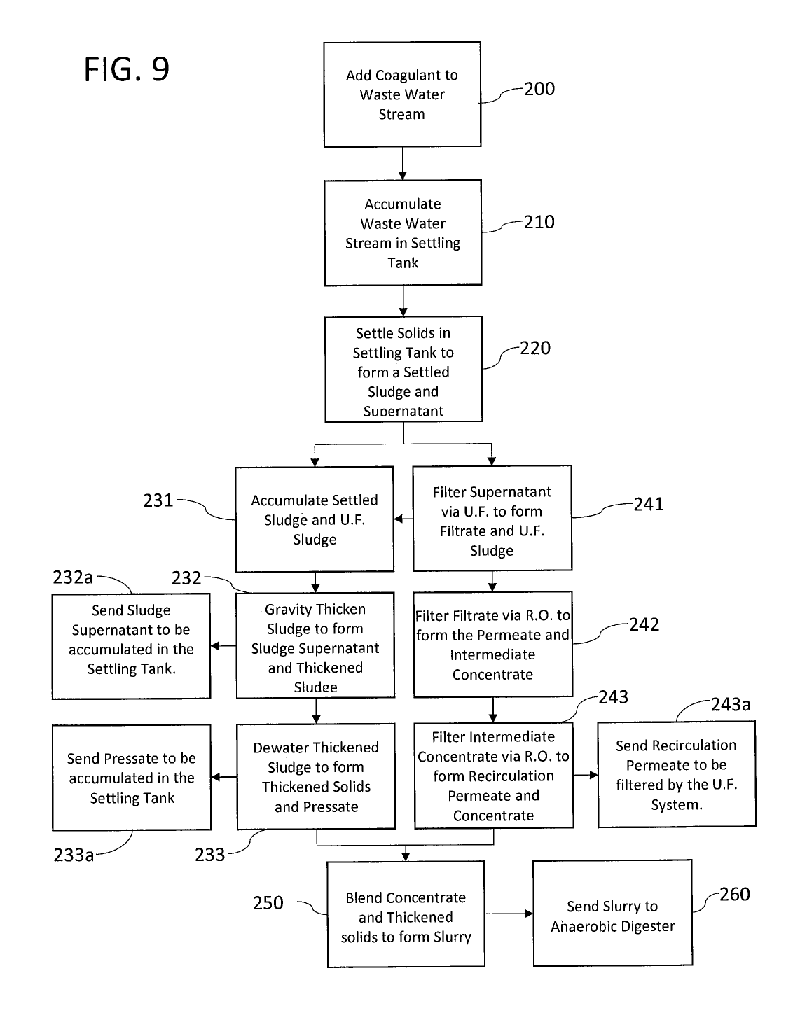

In operation, and with reference to FIG. 6 and FIG. 9, in a currently preferred embodiment in step 200 a coagulant is added to the waste stream prior to step 210 wherein the waste stream 22 is accumulated in settling tank 130. Preferably, the coagulant comprises aluminum chlorohydrate, such as Kemira PAX-XL 1900 manufactured by Kemira Oyj. In a representative example, a waste stream comprising organic materials from food and beverage processing with total suspended solids of 75 mg/l to 5,000 mg/l and BOD between about 300 mg/L and 15,000 mg/L or more, coagulant Kemira PAX-XL 1900 is added to the waste stream at the rate of 100 mg to 800 mg per liter of waste water. Note that for purposes of the instant application, coagulant is meant to include compounds used to enhance coalescence of solids, including without limitation materials commonly referred to as flocculants. Further, the coagulant may comprise ferric chloride or other compounds including without limitation anionic and cationic polymers as the requirements of the application dictate.

In a currently preferred embodiment, the coagulant is added to the influent stream via dosing apparatus 25′ (Reference FIG. 2) and dispersed via static mixer 40′.

After accumulating the process waste water in the settling tank, and with reference to step 220, solids settle to the bottom of the settling tank during a “settle time” resulting in the formation of a sludge and a supernatant. Both the sludge and the supernatant may contain significant nutrients that can be used, as for instance in an anaerobic digester, to produce methane. Generally, the supernatant will have a relatively greater concentration of nutrients dissolved in the fluid and a relatively lesser concentration of suspended particles when compared to the sludge.

In a preferred embodiment using the settling tank 130 (reference FIG. 2) disclosed in the '987 application, more than 90% of particulate matter is efficiently extracted from the process waste water to form a sludge high in BOD and phosphorous. Preferably, the supernatant of step 220 is decanted from preferable settling tank 130 via a decanter assembly 1400 to remove residual particulate matter larger than the pore size of screens 1500 as described elsewhere in this instant application with reference to FIG. 3 and FIG. 4. It is further preferable that screens 1500 have a pore size in the range of 25-75 micrometers, and most preferably about 50 micrometers. Removal of particulates from the supernatant via screens 1500 reduces the likelihood and frequency of membrane fouling in subsequent filtration steps, thereby increasing the life of the filtration systems and improving their throughput by reducing the frequency of backwash and CIP cycles; e.g., the UF system membranes of step 241. In this preferred embodiment, the supernatant decanted via decanter assembly 1400 to produce screened waste water 87 (FIG. 2.) corresponds to supernatant 23 of FIG. 1 and FIG. 6. Important nutrients such as sugars, alcohols, fatty acids, NPN (non-protein nitrogen), and other organic compounds will predominantly remain solvated or suspended in the supernatant. To extract and concentrate the nutrients from the sludge and the supernatant distinct further process steps are used.

In step 241, the supernatant 23 from step 200 is filtered via an ultrafiltration system 140 to form an ultrafiltration filtrate and a UF sludge. As disclosed elsewhere in this application with respect to FIG. 8, when the concentration of the rejected materials in the feed tank 142 exceeds a threshold level, ultrafiltration sludge 32, containing valuable nutrients, is discharged from the ultrafiltration system 140 to sludge tank 170.

In step 242, ultrafiltration filtrate is filtered by reverse osmosis system 150. As is well known in the art, in operation a reverse osmosis system passes a fraction of the incoming water through the reverse osmosis membranes to produce a permeate with a lower concentration of dissolved materials relative to the incoming fluid and rejects a fraction of the incoming water to produce a concentrate with a higher concentration of dissolved materials relative to the incoming fluid. The permeate 25 discharged by system 11 as finished water. However, the concentrate from reverse osmosis system 150, hereinafter referred to as “intermediate concentrate” 33, has valuable nutrients that can be extracted.

When extracting nutrients from a waste stream it is desirable to concentrate them, minimizing the volume of liquid to be handled while returning the greatest possible fraction of clean water for reuse. The intermediate concentrate 33 nutrient concentration is relatively low. To further concentrate the nutrients, in step 243, the intermediate concentrate is filtered by reverse osmosis concentrate recovery system 160 to form recirculation permeate 43 and concentrate 44. In a currently preferred embodiment, the concentrate 44 nutrient concentration is increased by a factor of about 3 when compared to the intermediate concentrate nutrient concentration. To extract the greatest fraction of clean water from the system 11 the recirculation permeate 43 is delivered to the ultrafiltration system 140. The concentrate 44 is delivered to blender 190 as described in more detail elsewhere in the instant application.

Returning to step 220, settled sludge 31 is discharged from settling tank 130 to sludge tank 170. In step 231, settled sludge 31 and UF sludge 32 are accumulated in sludge tank 170. The accumulated sludge is thickened via settling of suspended particulates (gravity thickening) to form sludge supernatant 42 and a thickened sludge 34 (reference FIG. 7) that further concentrates nutrients and other valuable organic and inorganic matter that is primarily in particulate form. The sludge may be allowed to settle for hours or days depending upon the settling rates of the particulates, size of the sludge tank, and desired thickening. The sludge supernatant 42 is delivered to the equalization tank 110 to recapture the water for reuse. In a current embodiment, the sludge supernatant 42 is pumped to the equalization tank 110, although other mechanisms for delivery may be suitable based on the needs of the application, including by way of example and not limitation, gravity feed.

After desired gravity thickening has occurred, thickened sludge 42 is dewatered to form thickened solids 23 and pressate 41. In a currently preferred embodiment, thickened sludge 34 is dewatered with belt filter press 180. The pressate 41 is delivered to the equalization tank 110 to recapture the water for reuse. In a current embodiment, the pressate 41 is pumped to the equalization tank 110, although other mechanisms for delivery may be suitable based on the needs of the application, including by way of example and not limitation, gravity feed.

Belt filter presses to dewater sludge are well known in the art. Alternatively, dewatering of gravity thickened sludge 34 may be accomplished by other apparatus, including without limitation, a centrifuge, rotary press, filter press, and screw press as dictated by the needs of the application.

In a current embodiment, the thickened sludge 34 contains about 1%-3% solids by weight prior to dewatering in step 233, whereas the thickened solids after dewatering are about 25%-40% solids by weight. While the thickened solids are desirably concentrated, the high-solids content presents a challenge for transport of the solids away from system 11 via traditional slurry or positive displacement pumps. Additionally, there are valuable nutrients in the concentrate 44 that are preferably recovered. To simplify transport of the nutrients and solid matter in step 250 and produce a single material containing the extracted nutrients, the thickened solids 35 are blended by a blender 190 with the concentrate 44 to form a slurry 36. Blenders are well known in the art. By way of example and not limitation, in a current embodiment, the blender comprises a XRipper XRL Food Waste Grinder manufactured by Vogelsang. Alternative blenders, including macerators, grinders, and the like may be used as dictated by the needs of the application. In a current embodiment, the slurry 36 is pumped via positive displacement pumps 195 to an anaerobic digester. However, the slurry 36 may easily be transported via other means including without limitation, gravity, screw conveyer, bucket elevator, and the like as dictated by the needs of the application. Similarly, the slurry may be transported to trucks for hauling, agricultural fields for application, or other post-processing steps as dictated by the requirements of the application.

What is claimed is:

1. A method to separate nutrients from a waste stream comprising the steps of:
a) accumulating said waste stream in a settling tank;
b) settling solids in said settling tank to form a supernatant and a settled sludge;
c) filtering the supernatant with a filtration system to form a first permeate and a first concentrate;
d) dewatering said settled sludge to form thickened solids and a pressate; and
e) blending said thickened solids and said concentrate to form a slurry.

2. The method of claim 1 further comprising the step of delivering said slurry to an anaerobic digester.

3. The method of claim 1 further comprising the step of adding a coagulant to said waste stream prior to said step of settling solids in said settling tank.

4. The method of claim 1 wherein, the said step of dewatering said settled sludge further comprises gravity thickening of said settle sludge to form a sludge supernatant and a thickened sludge.

5. The method of claim 4, further comprising the step of accumulating said sludge supernatant in said settling tank.

6. The method of claim 1 wherein, the step of dewatering said settled sludge comprises using apparatus selected from the group consisting of: a belt filter press, a centrifuge, a rotary press, a screw press, and a plate filter press.

7. The method of claim 1 wherein the step of filtering said supernatant comprises filtering with a filtration system selected from the group consisting of micro-filtration, ultra-filtration, nano-filtration, and reverse osmosis.

8. The method of claim 1, wherein the step of filtering said supernatant with a filtration system comprises the steps of:
a) filtering said supernatant with an ultrafiltration system to form an ultrafiltration sludge and an ultrafiltration filtrate; and,
b) filtering said ultrafiltration filtrate with a reverse osmosis system to form said first permeate and said first concentrate.

9. The method of claim 8 further comprising the step of dewatering said ultrafiltration sludge.

10. The method of claim 8 wherein filtering said filtrate with a reverse osmosis system further comprises the steps of:
a) filtering said filtrate with a first reverse osmosis component to form said first permeate and a second concentrate;
b) filtering said second concentrate with a second reverse osmosis component to form said first concentrate and a second permeate.

11. The method of claim 9 further comprising the step of accumulating said pressate in said settling tank.

12. A method to separate nutrients from a waste stream comprising the steps of:
a) accumulating said waste stream in a settling tank;
b) settling solids in said settling tank to form a settled sludge and a supernatant;
c) filtering said supernatant with an ultrafiltration system to form an ultrafiltration sludge and a filtrate;
d) filtering said filtrate with a reverse osmosis system to form a first permeate and a first concentrate,
e) dewatering said settled sludge to form thickened solids and a pressate;
f) blending said thickened solids and the first concentrate to form a slurry.

13. The method of claim 12 further comprising delivering said slurry to an anaerobic digester.

14. The method of claim 12 further comprising adding a coagulant to said waste stream prior to the step of settling solids in said settling tank.

15. The method of claim 12 further comprising the steps of:
a) dewatering said settled sludge by gravity thickening to form a sludge supernatant and a thickened sludge;
b) dewatering said thickened sludge to form said thickened solids and said pressate.

16. The method of claim 15 further comprising the step of accumulating said sludge supernatant in said settling tank.

17. The method of claim 12 further comprising the steps of:
a) accumulating said waste stream in an equalization tank before said step of accumulating said waste stream in a settling tank; and,
b) discharging said waste stream to said settling tank.

18. The method of claim 17 further comprising the step of accumulating pressate in said equalization tank.

19. The method of claim 12 wherein filtering said filtrate with a reverse osmosis system further comprises the steps of:
a) filtering said filtrate with a first reverse osmosis component to form said first permeate and a second concentrate;
b) filtering said second concentrate with a second reverse osmosis component to form said first concentrate and a second permeate.

20. The method of claim 18 further comprising the step of filtering said second permeate with said ultrafiltration system.
